(19) United States
(12) Patent Application Publication
(10) Pub. No.: US 2024/0408837 A1
(43) Pub. Date: Dec. 12, 2024

(54) BOX ERECTING MACHINE

(71) Applicant: PACKSIZE LLC, Salt Lake City, UT (US)

(72) Inventors: Johan Blomberg, Uppsala (SE); Fredrik Hisvals, Salt Lake City, UT (US)

(21) Appl. No.: 18/735,990

(22) Filed: Jun. 6, 2024

Related U.S. Application Data
(60) Provisional application No. 63/471,306, filed on Jun. 6, 2023.

(51) Int. Cl. B31B 50/26; B31B 50/62; B31B 100/00; B31B 110/35

(52) U.S. Cl. CPC B31B 50/262; B31B 50/62; B31B 2100/0024; B31B 2110/35; B31B 2247/00

(57) ABSTRACT

A system for forming boxes includes a folding and glue module. The folding and glue module includes a side folding unit configured to fold opposing sidewalls of a box template, a glue system configured to apply glue to selected portions of the box template as the box template advances through the side folding unit, a front folding unit configured to fold front glue flaps and a front wall panel of the box template, and a rear folding unit configured to fold rear glue flaps and a rear wall panel of the box template.

### CROSS REFERENCE TO RELATED APPLICATIONS

This application claims priority to U.S. Provisional Patent Application No. 63/471,306, the entirety of which is incorporated herein by reference for all purposes.

### BACKGROUND

### The Field of the Invention

Exemplary embodiments of the disclosure relate to systems, methods, and devices for forming boxes. More specifically, the present disclosure relates to systems, methods, and devices for erecting box templates into boxes.

### The Relevant Technology

Shipping and packaging industries frequently use paperboard and other sheet material processing equipment that converts sheet materials into box templates. One advantage of such equipment is that a shipper may prepare boxes of required sizes as needed in lieu of keeping a stock of standard, pre-made boxes of various sizes. Consequently, the shipper can eliminate the need to forecast its requirements for particular box sizes as well as to store pre-made boxes of standard sizes. Instead, the shipper may store one or more bales of fanfold material, which can be used to generate a variety of box sizes based on the specific box size requirements at the time of each shipment. This allows the shipper to reduce storage space normally required for periodically used shipping supplies as well as to reduce the waste and costs associated with the inherently inaccurate process of forecasting box size requirements since the items shipped and their respective dimensions vary from time to time.

In addition to reducing the inefficiencies associated with storing pre-made boxes of numerous sizes, creating custom sized boxes also reduces packaging and shipping costs. In the fulfillment industry it is estimated that shipped items are typically packaged in boxes that are about 65% larger than the shipped items. Boxes that are too large for a particular item are more expensive than a box that is custom sized for the item due to the cost of the excess material used to make the larger box. When an item is packaged in an oversized box, filling material (e.g., Styrofoam, foam peanuts, paper, air pillows, etc.) is often placed in the box to prevent the item from moving inside the box and to prevent the box from caving in when pressure is applied (e.g., when boxes are taped closed or stacked). These filling materials further increase the cost associated with packing an item in an oversized box.

Custom sized boxes also reduce the shipping costs associated with shipping items compared to shipping the items in oversized boxes. A shipping vehicle filled with boxes that are 65% larger than the packaged items is much less cost efficient to operate than a shipping vehicle filled with boxes that are custom sized to fit the packaged items. In other words, a shipping vehicle filled with custom sized packages can carry a significantly larger number of packages, which can reduce the number of shipping vehicles required to ship the same number of items. Accordingly, in addition or as an alternative to calculating shipping prices based on the weight of a package, shipping prices are often affected by the size of the shipped package. Thus, reducing the size of an item's package can reduce the price of shipping the item. Even when shipping prices are not calculated based on the size of the packages (e.g., only on the weight of the packages), using custom sized packages can reduce the shipping costs because the smaller, custom sized packages will weigh less than oversized packages due to using less packaging and filling material.

Previous box forming systems have required the use of multiple machines (e.g., a converting machine that cuts, scores, and/or creases sheet material to form a box template; a gluer that glues portions of the box template together; a taper that tapes portions of the box template together) and significant manual labor (e.g., to erect the box template into an open box; fold the bottom flaps closed).

Accordingly, it would be advantageous to have a machine that can take a previously formed box template and erect a box into an open box that is ready to be filled with minimal or no manual labor required.

### BRIEF SUMMARY

Exemplary embodiments of the disclosure relate to systems, methods, and devices for erecting box templates into boxes. For instance, one embodiment is directed to a system for forming boxes. The system includes a folding and glue module. The folding and glue module includes a side folding unit configured to fold opposing sidewalls of a box template, a glue system configured to apply glue to selected portions of the box template as the box template advances through the side folding unit, a front folding unit configured to fold front glue flaps and a front wall panel of the box template, and a rear folding unit configured to fold rear glue flaps and a rear wall panel of the box template.

According to another embodiment, a system for forming boxes includes a folding module. The folding unit includes a side folding unit configured to fold opposing sidewalls of a box template, a front folding unit configured to fold front glue flaps and a front wall panel of the box template, and a rear folding unit configured to fold rear glue flaps and a rear wall panel of the box template. A portion of the front folding module is selectively movable between the side folding unit and the rear folding unit to transfer the box template there between. In preferred embodiments, the front folding unit shuttles the box template between the side folding unit and the rear folding unit, and folds the front blue flaps and a front wall panel of the box template while the box template is being transferred from the side folding unit to the rear folding unit. This configuration has certain advantages over prior art systems and methods, primarily, increased throughput. In the machine configured according to preferred embodiments, the box template does not stop advancing through the erecting machine, except for a brief pause at the rear folding unit. This enables advantageously high throughput relative to previous machines.

Additionally, in preferred embodiments, the side folding unit comprises two folding units that are translatable laterally with respect to an axis of motion of the box template unit as it transits the machines. This enables the side folding unit to fold the box template along creases in box templates at arbitrary lateral positions on the box. The preferred machine translates the box template to the folding positions in the front and rear folding units, which are then positioned to fold the box template at creases running transverse to the axis of motion of the box. Together, these features enable preferred machines of the disclosure to fabricate boxes of arbitrary size, the size to be determined only by the width of the box bale material, and positions of the creases, which may be controllably placed arbitrarily. This is advantageous because it permits fabrication of boxes of arbitrary size (within the limits set by the width of the bale material), and as significantly, permits the machine to change the size of the box, on the fly, without interrupting or reducing the rate of box throughput.

These and other objects and features of the present disclosure will become more fully apparent from the following description and appended claims, or may be learned by the practice of the disclosure as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only illustrated embodiments of the invention and are therefore not to be considered limiting of its scope. The invention will be described and explained with additional specificity and detail through the use of the accompanying drawings in which:

FIG. 1 illustrates a box forming system;

FIGS. 2A-2C illustrate a box erecting module of the box forming system of FIG. 1;

FIGS. 3A-5 illustrate a side folder unit of the box erecting module of FIGS. 2A-2C;

FIGS. 6-11B illustrate a front folding station of the box erecting module of FIGS. 2A-2C;

FIGS. 12-17B illustrate a rear folding station of the box erecting module of FIGS. 2A-2C; and

FIGS. 18A-18F illustrate an example folding process for folding a box template using the box erecting module of FIGS. 2A-2C.

### DETAILED DESCRIPTION

Exemplary embodiments of the disclosure relate to systems, methods, and devices for forming boxes. More specifically, the described embodiments relate to methods and devices for erecting box templates into boxes.

While the present disclosure will be described in detail with reference to specific configurations, the descriptions are illustrative and are not to be construed as limiting the scope of the present invention. Various modifications can be made to the illustrated configurations without departing from the spirit and scope of the invention as defined by the claims.

As used herein, the term “bale” shall refer to a stock of sheet material that is generally rigid in at least one direction, and may be used to make a box template. For example, the bale may be formed of a continuous sheet of material or a sheet of material of any specific length, such as paperboard, corrugated cardboard, and cardboard sheet materials. Additionally, the bale may have stock material that is substantially flat, folded, or wound onto a bobbin.

As used herein, the term “box template” shall refer to a substantially flat stock of material that can be erected into a box-like shape. A box template may have notches, cutouts, divides, and/or creases that allow the box template to be bent and/or folded into a box. The notches, cutouts, divides, and/or creases in the box template may at least partially define various panels and/or flaps that will form the sides, bottom, and optionally top of a box formed from the box template. Additionally, a box template may be made of any suitable material, generally known to those skilled in the art. For example, cardboard or corrugated paperboard may be used as the box template material. A suitable material also may have any thickness and weight that would permit it to be bent and/or folded into a box-like shape.

As used herein, the term “crease” shall refer to a line along which the box template may be folded. For example, a crease may be a line of weakness that causes the box to fold, at the crease, preferentially, when the box is held at a fixed position near the crease with a force in a first direction, and a force in an opposite direction is applied in an opposite direction distal from the crease. For example, a crease may be an indentation in the box template material, which may aid in folding portions of the box template separated by the crease, with respect to one another. A suitable indentation may be created by applying sufficient pressure to reduce the thickness of the material in the desired location and/or by removing some of the material along the desired location, such as by scoring.

The terms “notch,” “cutout,” and “cut” are used interchangeably herein and shall refer to a shape created by removing material from the template or by separating portions of the template, such that a divide through the template material is created.

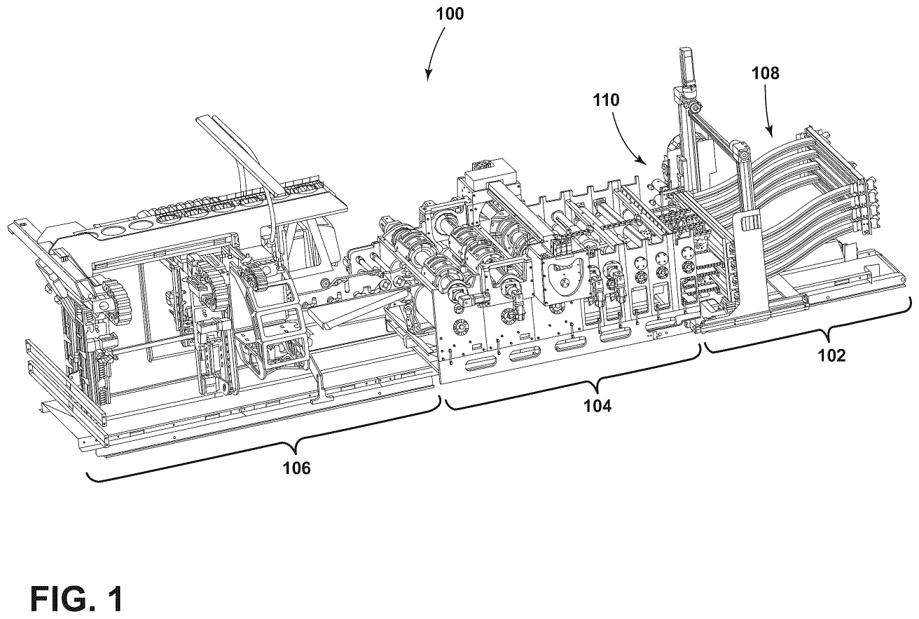

FIG. 1 illustrates a perspective view of a system 100 that may be used to create box templates and erect the box templates into boxes. The system 100 includes an infeed module 102, a converting module 104, and a folding and glue module 106 (also referred to as folding module 106).

The infeed module 102 is configured to direct sheet material from one or more sheet material sources (e.g., bales or rolls of sheet material) into the converting module 104. In the illustrated embodiment, the infeed module 102 includes a plurality of guides 108 and a feed changer 110. The plurality of guides 108 are configured to guide the different sheet materials from their respective sheet material sources to the feed changer 110. The feed changer 110 is adjustable in order to change which sheet material is fed into the converting module 104.

The converting module 104 is configured to perform one or more conversion functions on the sheet material in order to convert the sheet material into box templates. The conversion functions may include forming cuts, creases, scores, notches, and the like in the sheet material to create various panels, flaps, and the like of the box template. Example mechanisms and processes for converting sheet materials into box templates are disclosed in U.S. patent application Ser. No. 16/814,509, filed Mar. 10, 2020, and entitled Packaging Machine and Systems (the '509 Application), the disclosure of which is incorporated herein by reference in its entirely. The mechanisms and processes disclosed in the '509 Application may be used in the converting module 104.

The box templates formed by the converting module 104 can be advanced into the folding module 106. The folding module 106 is configured to fold the box template into an open box and secure various panels or flaps of the box template together to hold the box together.

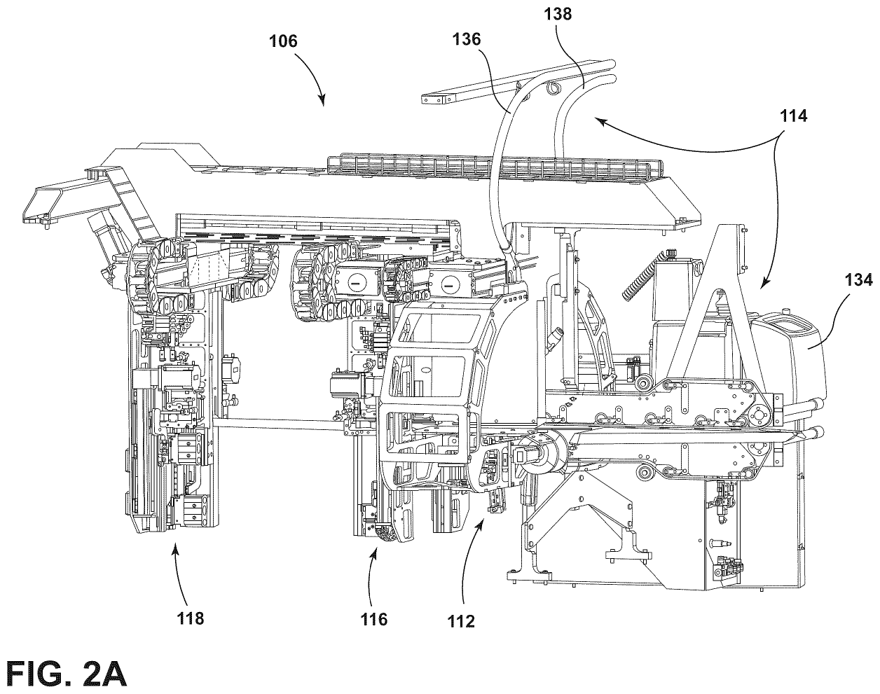

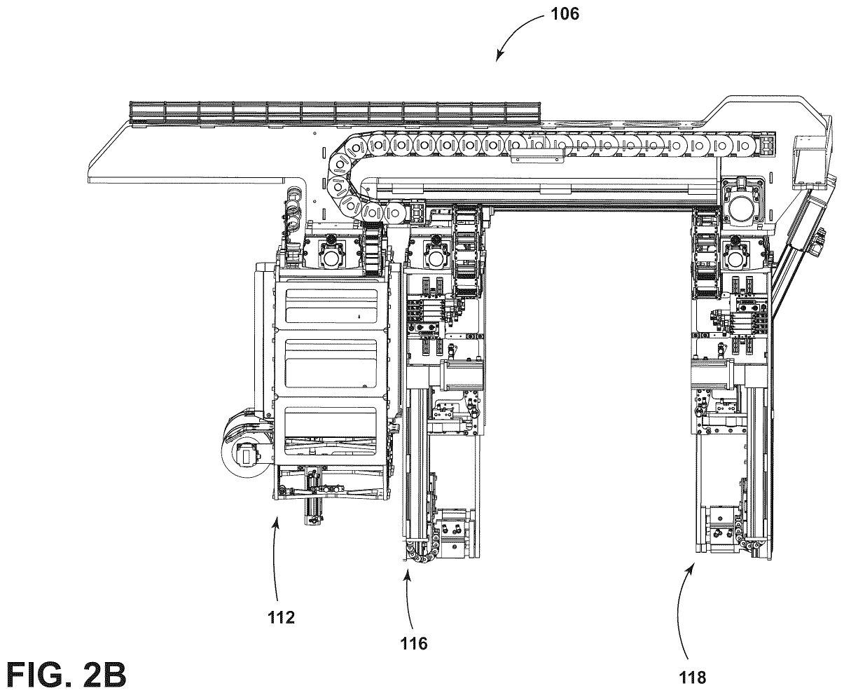

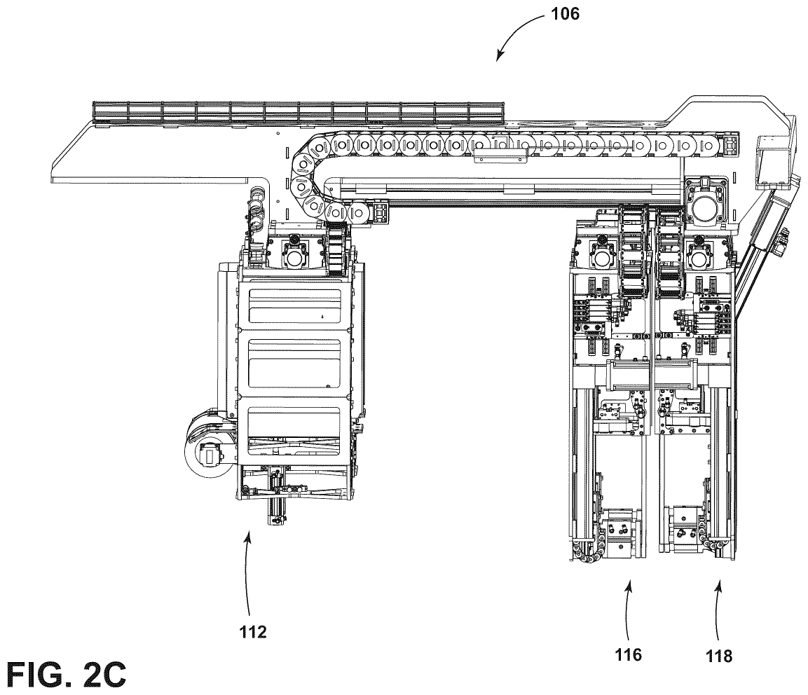

FIGS. 2A-2C illustrate the folding module 106 apart from the rest of the system 100. The folding module 106 includes a side folding unit 112, a glue system 114, a front folding unit 116, and a rear folding unit 118, each of which will be discussed in greater detail below. Briefly, however, the side folding unit 112 is configured to fold side panels of a box template relative to a bottom panel thereof to form a partially folded box. While the partially folded box is advancing through the side folding unit 112, the glue system 114 is configured to apply glue to one or more panels of the partially folded box.

The partially folded box is then transferred to the front folding unit 116. The front folding unit 116 is configured to fold glue flaps and a front end wall of the box template and secure the glue flaps and the end wall together with the previously applied glue to form a front end of a box. Portions of the front folding unit 116 are configured to move back and forth between the side folding unit 112 and the rear folding unit 118. For instance, after or while the front folding unit 116 is folding and securing the front end of the box, portions of the front folding unit 116 can move towards the rear folding unit 118 (compare FIGS. 2A, 2B with FIG. 2C) in preparation to transfer the partially folded box to the rear folding unit 118. Once the partially folded box is transferred to the rear folding unit 118, the front folding unit 116 can move back towards the side folding unit 112 (FIG. 2A, 2B) to receive another partially folded box.

The rear folding unit 118 is configured to fold glue flaps and a rear end wall of the box template and secure the glue flaps and the rear end wall together with the previously applied glue to form a rear end of the box. With the rear end of the box secured, the box template has been erected into a box.

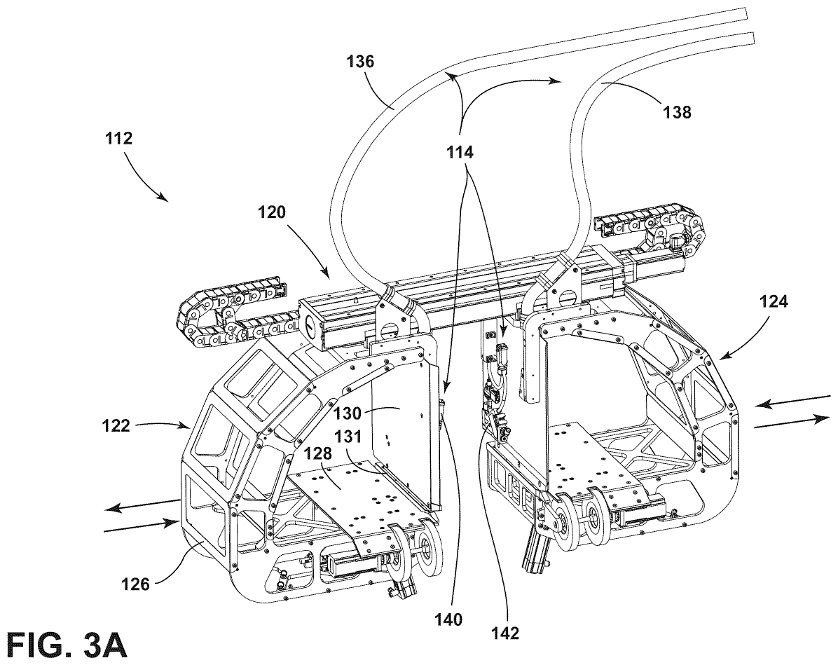

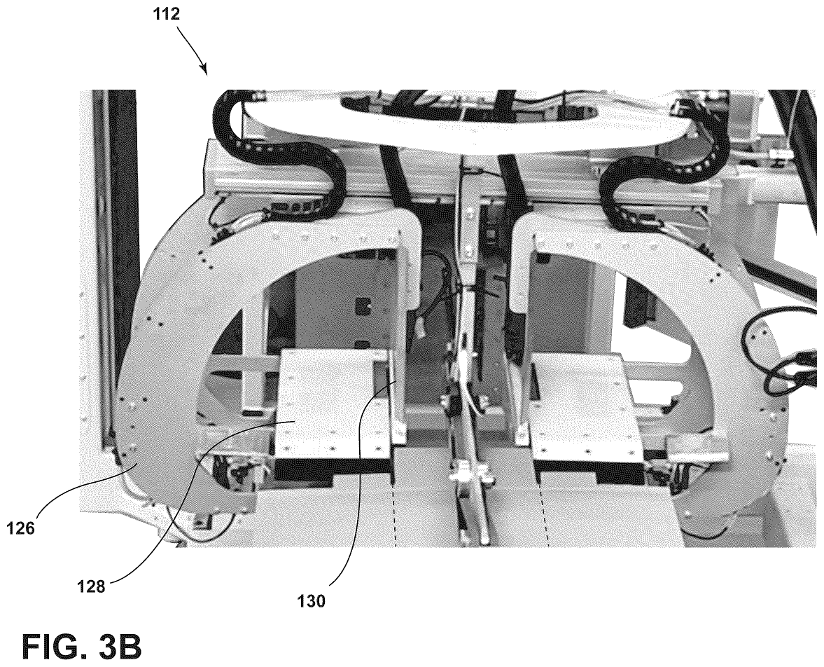

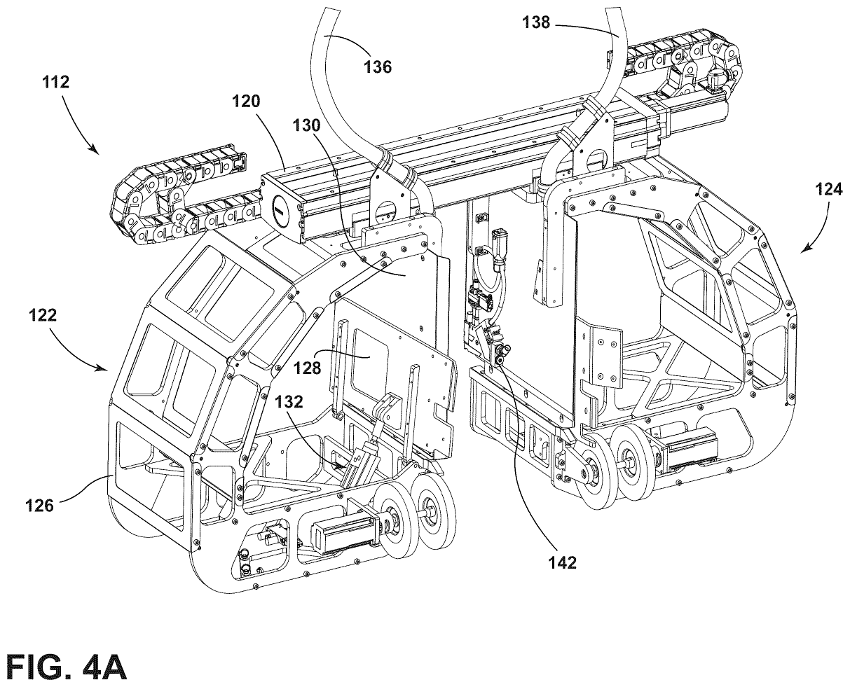

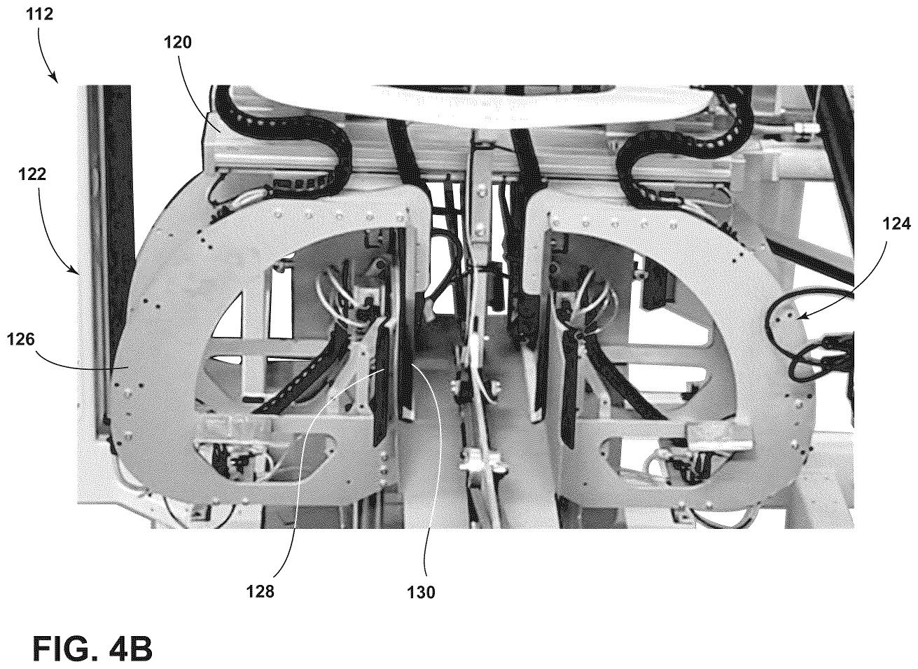

FIGS. 3A-4B illustrate the side folding unit 112 in more detail. In the illustrated embodiment, the side folding unit 112 includes a track 120, a first folder assembly 122 and a second folder assembly 124. The first folder assembly 122 and the second folder assembly 124 are movably connected to the track 120 so as to accommodate box templates of various sizes. For instance, the first folder assembly 122 and the second folder assembly 124 may move along the track 120 further apart or closer together to accommodate wider or narrower box templates. In some embodiments, the first folder assembly 122 and the second folder assembly 124 move symmetrically relative to a reference line or point. For instance, the first folder assembly 122 and the second folder assembly 124 may move similar distances as one another but in opposite directions. In some embodiments, the movements of the first folder assembly 122 and the second folder assembly 124 are linked to one another to automatically cause the symmetrical movements. In other embodiments, the first folder assembly 122 and the second folder assembly 124 can move independently from one another and the movements may or may not be symmetrical.

In the illustrated embodiment, the first folder assembly 122 and the second folder assembly 124 are substantially identical to one another other than being mirror images of each other. Accordingly, the following discussion will focus primarily on the first folder assembly 122, with the understanding that the description thereof is germane to the second folder assembly 124.

As can be seen in FIGS. 3A-4B, the first folder assembly 122 includes a frame 126 that is movably connected to the track 120. The movement of the frame 126 relative to the track 120 (in the directions indicated by the arrows) can be powered via one or more actuators (e.g., motors, solenoids, etc.) and controlled to position the first folder assembly 122 at a desired position based on a width of a box template to be folded.

The first folder assembly 122 also includes a fold plate 128 and a wall 130 that are configured to facilitate folding of a side panel of a box template relative to a bottom panel thereof. The first folder assembly 122 can be moved along the track 120 so that the wall 130 (or an outer surface thereof) may be aligned with or just inside a crease (shown in dashed lines in FIG. 3B) formed in the box template between a bottom panel and side panels thereof. The box template is advanced into the side folding unit 112 so that the bottom panel thereof is positioned at least partially under the wall 130 and the side panel of the box template is positioned at least partially over the fold plate 128. When the box template is so positioned, the fold plate 128 can pivot or otherwise move to fold the side panel of the box template relative to the bottom panel thereof, as shown in FIGS. 4A, 4B. The wall 130 limits or prevents the bottom panel of the box template from lifting up during the folding operation. The wall 130 can also help ensure that the box template folds along the crease between the side panel and the bottom panel. Additionally, the wall 130 can limit the degree to which the side panel of the box template is folded. In the illustrated embodiment, the side folding unit 112 is configured to fold the side panels up to about 90° relative to the bottom panel of the box template.

The fold plate 128 can be pivotally connected to the frame 126 at one or more pivot points 131 to enable the fold plate 128 to fold the side panels of the box template. Additionally, an actuator 132 may be included to effectuate the pivoting movement of the fold plate 128. As can best be seen in FIG. 4A, the actuator 132 may be a piston that is connected between the frame 126 and the fold plate 128. Extension of the piston can cause the fold plate 128 to pivot to the position shown in FIGS. 4A, 4B to fold the side panel of the box template and retraction of the piston can cause the fold plate 128 to pivot back to the position shown in FIGS. 3A, 3B.

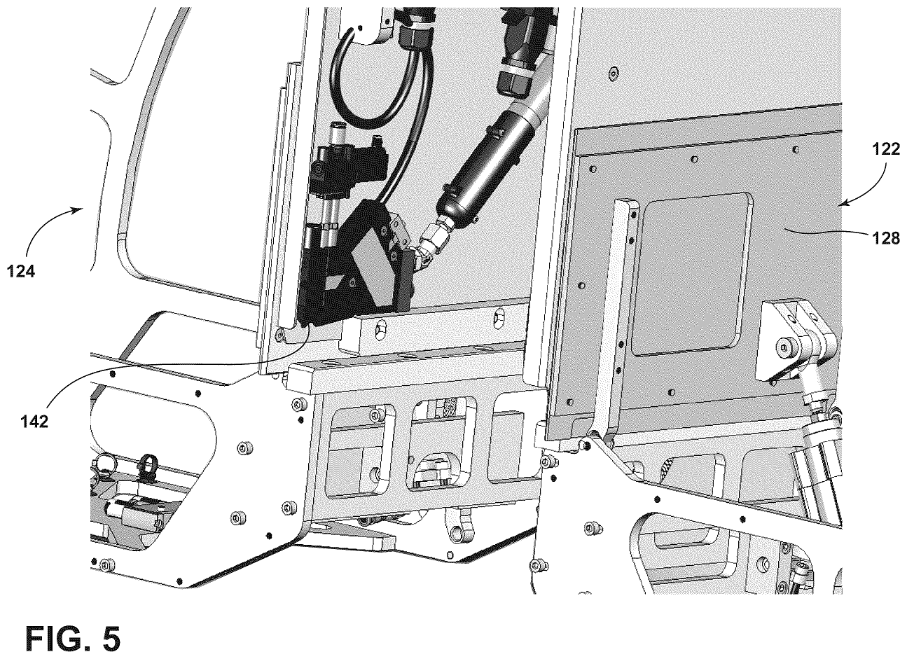

As can be seen in FIGS. 2A, 3A, 4A, and 5, the glue system 114 is associated with or partially incorporated into the side folding unit 112. The glue system 114 includes a glue reservoir 134 (FIG. 2A), glue conduits 136, 138 (FIGS. 3A, 4A), and glue nozzles 140, 142 (FIGS. 3A, 4A, 5). The glue conduits 136, 138 convey glue from the glue reservoir 134 to the glue nozzles 140, 142, respectively. The glue nozzle 140 is associated with the first folder assembly 122 and the glue nozzle 142 is associated with the second folder assembly 124. In the illustrated embodiment, the glue nozzles 140, 142 are mounted to the interior surfaces of the walls (e.g., wall 130) of the first and second folder assemblies 122, 124.

As the box template advances through the side folding unit 112, the glue nozzles 140, 142 are configured to apply glue to portions of the box template. For instance, the glue nozzles 140, 142 may be configured to apply glue adjacent to opposing edges of front and rear end wall panels of the box template. Movement of the first and second folder assemblies 122, 124 along the track 120 may be configured to properly position the glue nozzles 140, 142 to apply glue adjacent to the opposing edges of the front and rear end wall panels.

The glue system 114 may also include one or more sensors that are configured to detect the opposing (leading and trailing) ends of the front and rear end wall panels in order to determine when the glue nozzles 140, 142 should be activated and deactivated. Additionally, or alternatively, a control system can monitor the position of the box template as it moves through the folding module 106 and based on the particular dimensions and position of the box template, the control system may activate or deactivate the glue nozzles 140, 142 so that glue is only applied to desired portions of the box template.

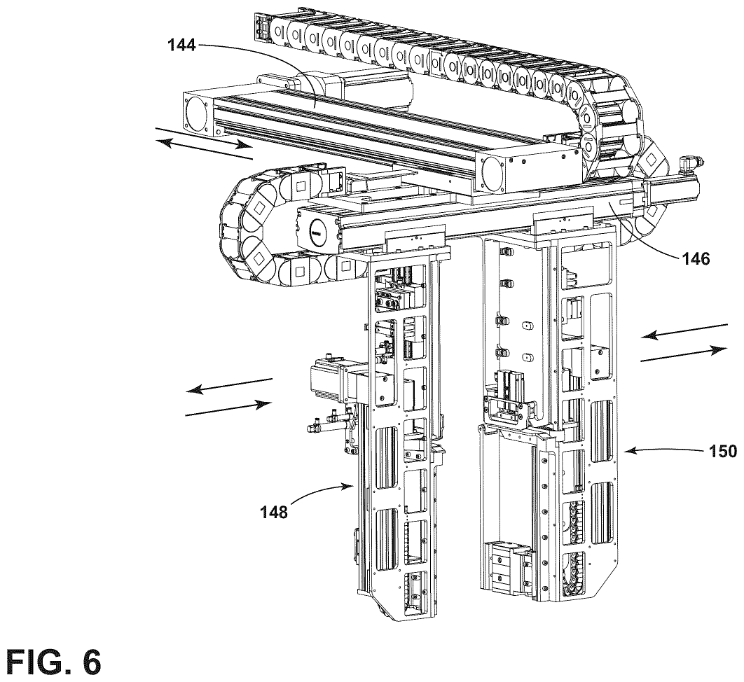

FIGS. 6-11B illustrate the front folding unit 116 in more detail. As can be seen in FIG. 6, the front folding unit 116 includes a first track 144 (may also be referred to as longitudinal track 144), a second track 146 (may also be referred to as lateral track 146), a first front folding assembly 148, and a second front folding assembly 150.

The first and second front folding assemblies 148, 150 are movably mounted on the second track 146 so as to accommodate box templates of various sizes. For instance, the first and second front folding assemblies 148, 150 may move along the second track 146 further apart or closer together (in the directions of the illustrated arrows) to accommodate wider or narrower box templates. In some embodiments, the first and second front folding assemblies 148, 150 move symmetrically relative to a reference line or point. In other embodiments, the first and second front folding assemblies 148, 150 can move independently from one another. One or more actuators may be used to achieve the movements of the first and second front folding assemblies 148, 150 along the second track 146.

The second track 146 is movably mounted on the first track 144 such that the second track 146 can move at least partially between opposing ends of the first track 144 in the directions of the illustrated arrows. Movement of the second track 146 relative to the first track 144 causes the first and second front folding assemblies 148, 150 to likewise move along the first track 144. The movement of the second track 146 relative to the first track 144 results in the movement of the first and second front folding assemblies 148, 150 as shown in FIGS. 2B, 2C. One or more actuators may be used to achieve the movements of the second track 146 along the first track 144.

In the illustrated embodiment, the first and second front folding assemblies 148, 150 are substantially identical to one another other than being mirror images of each other. Accordingly, the following discussion will focus primarily on the second front folding assembly 150, with the understanding that the description thereof is germane to the first front folding assembly 148.

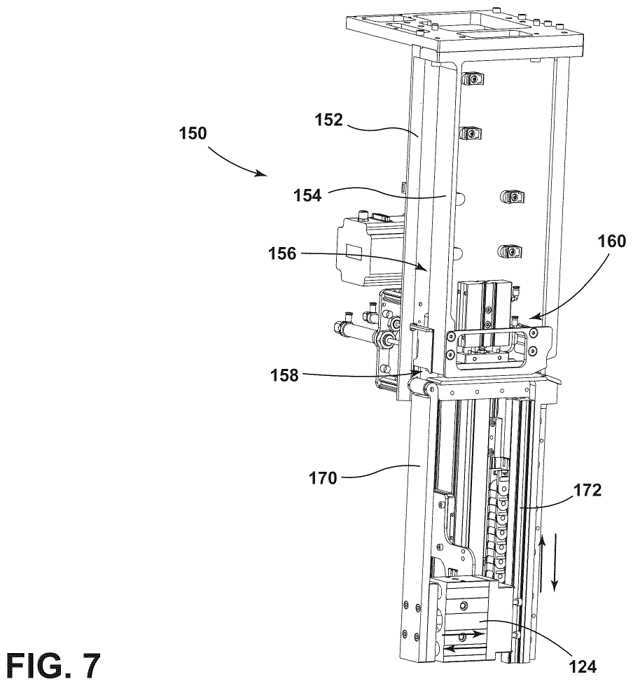

As can be seen in FIG. 7, the second front folding assembly 150 includes a frame 152 and a retention wall 154. A gap 156 is formed between at least a portion of the frame 152 and the retention wall 154. The gap 156 is sized and configured to receive therein the side panel of the partially folded box that was folded up by the second folder assembly 124. The frame 152 and the retention wall 154 are configured to maintain the side panel in the upwardly folded state.

The partially folded box can be advanced through the front folding unit 116 by an advancement mechanism 158 that is part of the second folding assembly 150. In the illustrated embodiment, the advancement mechanism 158 is a rotatable belt that is configured to engage the upwardly folded side panel of the partially folded box. In other embodiments, the advancement mechanism 158 may be a rotatable belt that is configured to engage the bottom panel of the partially folded box.

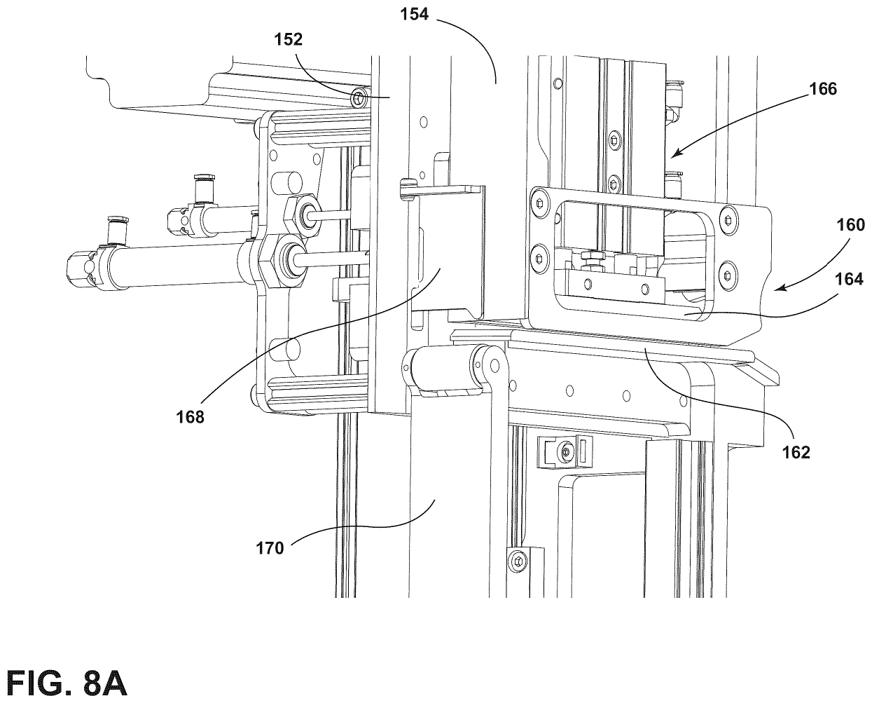

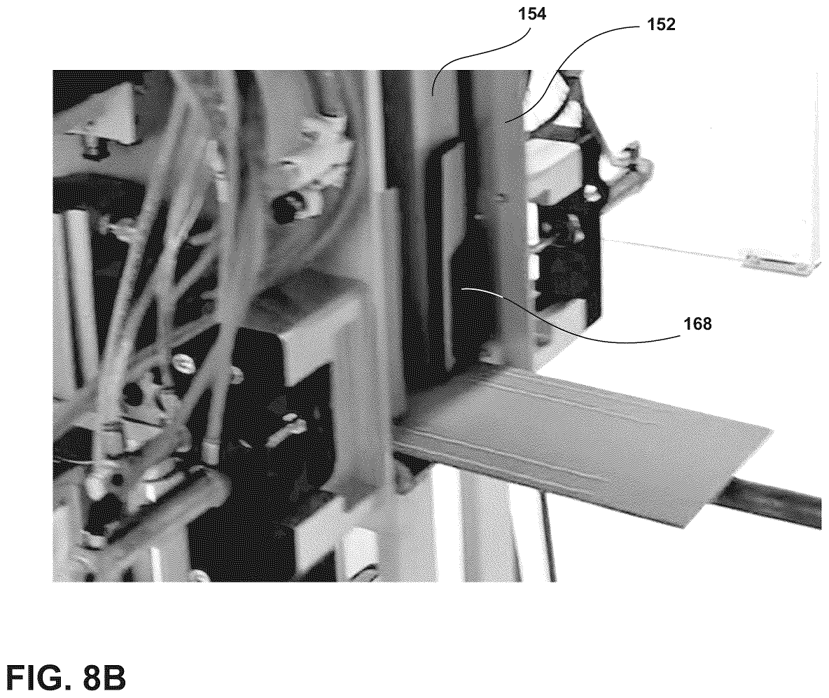

Advancement of the partially folded box through the front folding unit 116 can be paused when a crease between the front wall panel and the bottom panel of the partially folded box is aligned with a distal edge of the retention wall 154. Once the partially folded box is so positioned, a clamp 160 may be activated to hold the partially folded box in place. The clamp 160 includes a support surface 162 and a presser foot 164. The support surface 162 is configured to support the partially folded box from underneath. The presser foot 164 is configured to selectively move into engagement with the partially folded box to clamp the partially folded box between the presser foot 164 and the support surface 162. The presser foot 164 is shown in a lowered or clamped position in FIG. 8A. The presser foot 164 can be moved via an actuator 166, such as a piston, motor, worm gear, or the like.

With the partially fold box template held in place by the clamp 160, additional portions of the box template can be folded. For instance, as shown in FIGS. 8A, 8B, a glue flap folder 168 can be activated to fold a glue flap on the partially folded box. In the illustrated embodiment, the glue flap folder 168 moves linearly through a slot in the frame 152 to engage and fold the glue flap. An outer distal edge of the retention wall 154 may support the box template and help ensure that the glue flap folder 168 folds the box template along a crease formed between the glue flap and the side panel of the box template.

While the glue flap folder 168 is shown and described as moving linearly to fold the glue flap, this is merely exemplary. In other embodiments, the glue flap folder 168 may pivot or make another non-linear movement to engage and fold the glue flap.

With the glue flap folded, the front end wall panel of the box template can then be folded up to form a front end of the box. Folding the front end wall panel can be accomplished in two stages. In the first stage, the front end wall panel can be partially folded enough to be able to engage the folded glue flaps and limit or prevent them from unfolding. Once the front end wall panel is partially folded, the glue flap folders (glue flap folder 168) can be withdrawn and the front end wall panel can be fully folded into engagement with the glue flaps. The two stage folding process allows for the glue flap folders to be withdrawn and the front end wall panel to be folded into engagement with the glue flaps without the glue flaps unfolding or undesirably transferring glue from the front end wall panel to the glue flap folders.

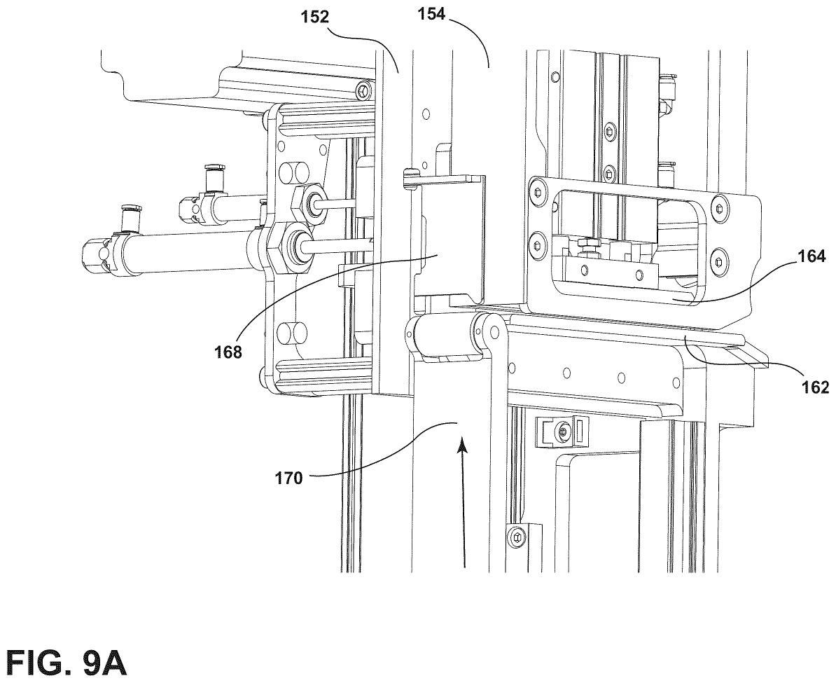

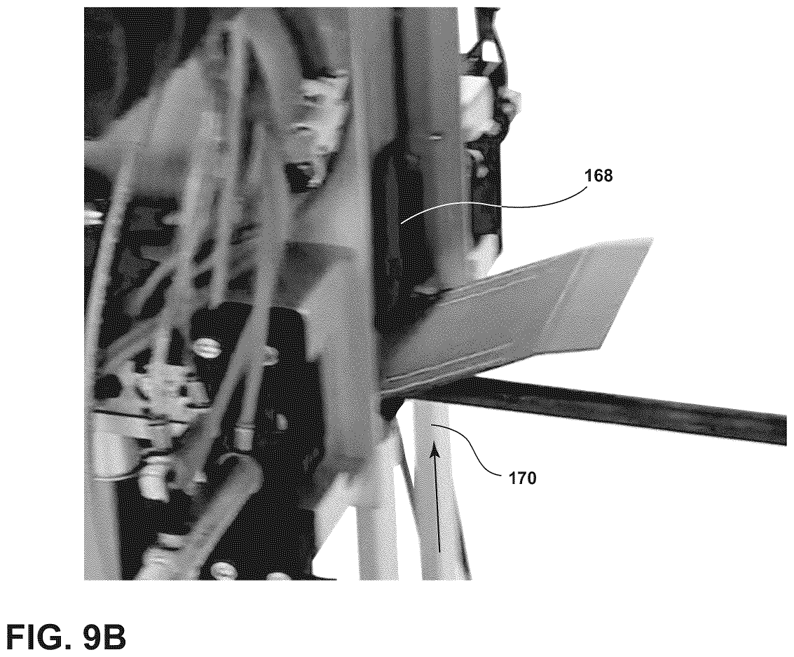

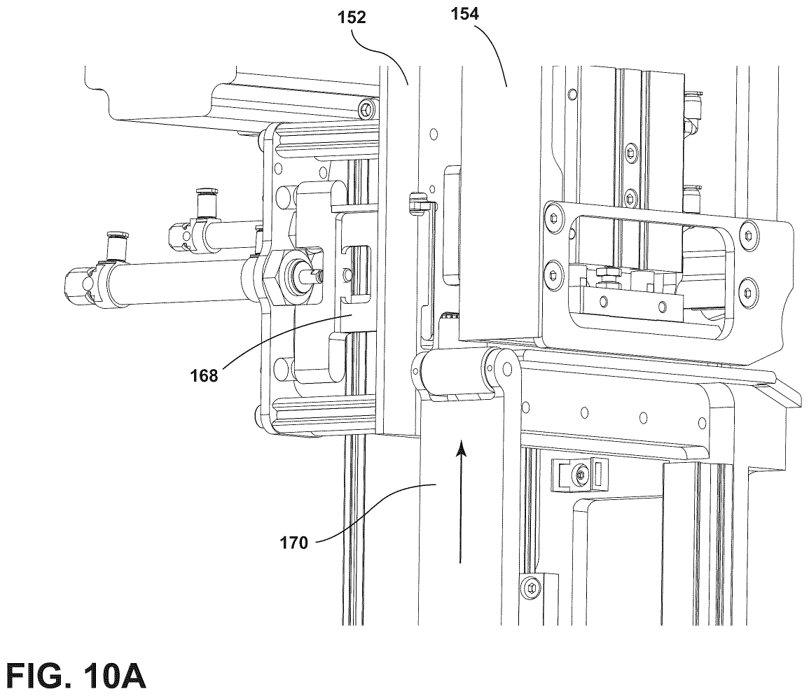

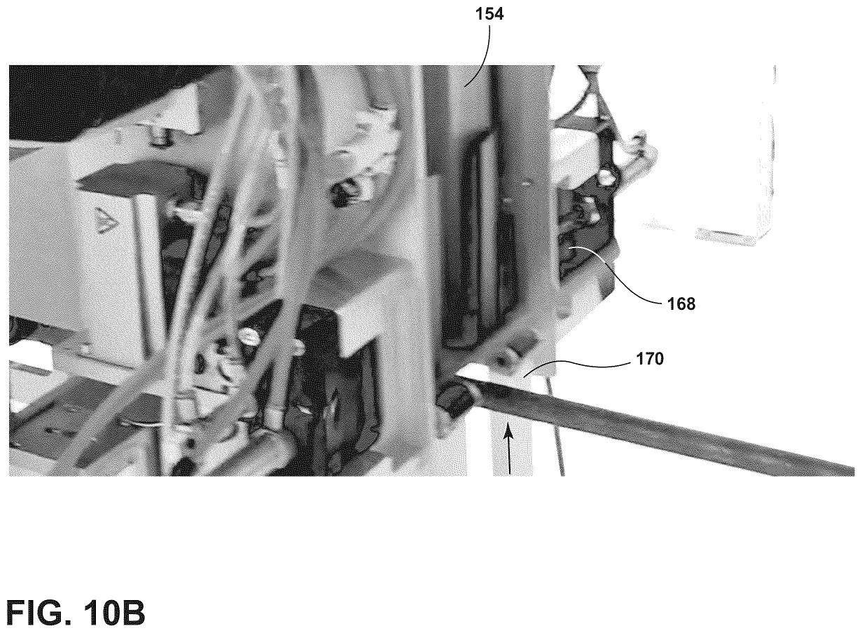

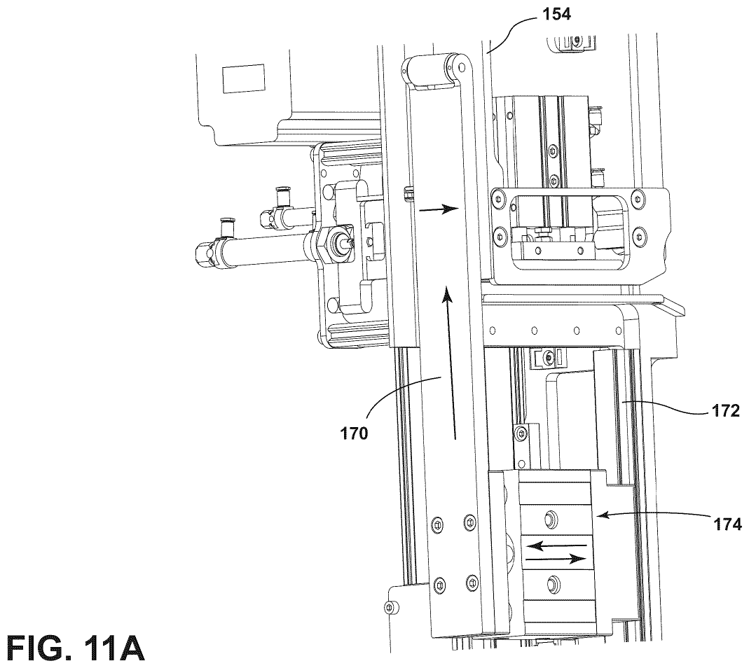

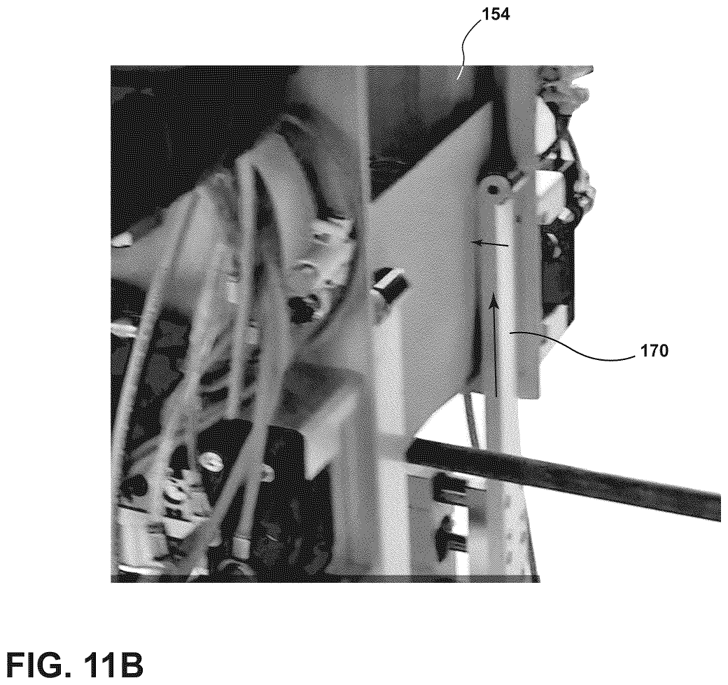

FIGS. 9A-10A illustrate the first stage of the front end wall folding process and FIGS. 10B-11B illustrate the second stage. As can be seen in FIGS. 9A-9B, the first stage of the front end wall panel folding process begins with a front end wall folder 170 moving in the direction of the illustrated arrow to engage an outer surface of the front end wall panel and partially folding the front end wall panel towards the glue flaps. As noted, partially folding the front end wall panel enables the front end wall panel to engage the bottom edges of the glue flaps, which can limit or prevent the glue flaps from unfolding when the glue flap folders are withdrawn.

The degree to which the front end wall panel is folded during the first stage can vary from one embodiment to another. For instance, the front end wall panel can be folded to an angle anywhere between 5° and 80°. The front end wall panel is folded far enough to engage the bottom edges of the glue flaps (to prevent them from unfolding) but not so far that the glue on the front end wall panel (seen in FIG. 9B) touches the glue flap folders.

With the front end wall panel folded sufficiently to prevent the glue flaps from unfolding, the glue flaps folders can be withdrawn as shown in FIG. 10A. Withdrawing the glue flap folders exposes the outer surfaces of the glue flaps to which the front end wall panel are to be secured. Thereafter, the front end wall folder 170 can move further in the direction illustrated by the arrow, as shown in FIGS. 10B-11B, to further and completely fold the front end wall panel. When the front end wall panel is completely folded, the glue on the front end wall panel can engage the glue flaps to secure the front end wall panel and the glue flaps together, thereby forming a front end of the box.

In some embodiments, the front end wall folder 170 can also move in a direction towards the glue flaps to compress the front end wall panel and the glue flaps together with the glue therebetween. An edge or side of the retention wall 154 may provide a support surface against which the front end wall folder 170 can press the front end wall panel and the glue flaps.

As can be seen in FIGS. 7 and 11A, the front end wall folder 170 is movably connected to a track 172. The front end wall folder 170 can move along at least a portion of the length of the track 172 to fold the front end wall panel as described herein. Optionally, the front end wall folder 170 can be connected to the track 172 via an actuator 174 that enables the front end wall folder 170 to move in a direction that facilitates compression of the front end wall panel and the glue flaps. The actuator 174 may be a piston, worm gear, or the like.

After or while the front end of the box is being folded and secured by the front folding unit 116, the first and second front folding assemblies 148, 150 can move along the track 144 towards the rear folding unit 118. The movement of the first and second front folding assemblies 148, 150 also moves the partially folded box towards the rear folding unit 118.

Once the front end of the box is formed and the first and second front folding assemblies 148, 150 have moved towards the rear folding unit 118, the partially folded box can be transferred to the rear folding unit 118. The transfer can begin by withdrawing the front end wall folder 170 (e.g., back to the position shown in FIGS. 7, 8A) and releasing the clamp 160 (e.g., by raising the presser foot 164 so the partially folded box is not clamped between the presser foot 164 and the support surface 162). The advancement mechanism 158 can then be activated to advance the partially folded box template into the rear folding unit 118. Once the partially folded box template is transferred to the rear folding unit 118, the first and second front folding assemblies 148, 150 can move back along the first track 144 towards the side folding unit 112 in preparation for receiving another partially folded box.

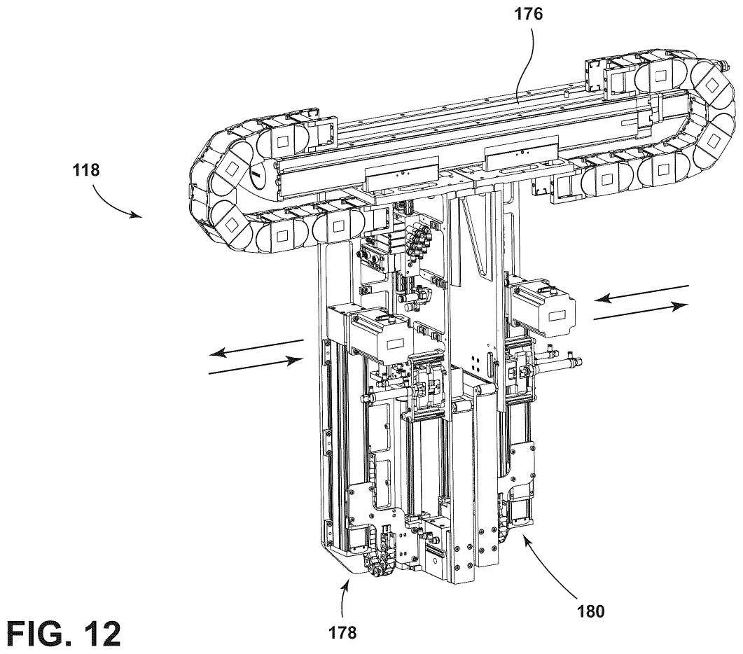

FIGS. 12-17B illustrate the rear folding unit 118 in more detail. As can be seen in FIG. 12, the rear folding unit 118 includes a track 176, a first rear folding assembly 178, and a second rear folding assembly 180. The first and second rear folding assemblies 178, 180 are movably mounted on the track 176 so as to accommodate box templates of various sizes. For instance, the first and second rear folding assemblies 178, 180 may move along the track 176 further apart or closer together (in the directions of the illustrated arrows) to accommodate wider or narrower box templates. In some embodiments, the first and second rear folding assemblies 178, 180 move symmetrically relative to a reference line or point. In other embodiments, the first and second rear folding assemblies 178, 180 can move independently from one another. One or more actuators may be used to achieve the movements of the first and second rear folding assemblies 178, 180 along the track 176.

In the illustrated embodiment, the first and second rear folding assemblies 178, 180 are substantially identical to one another other than being mirror images of each other. Accordingly, the following discussion will focus primarily on the second rear folding assembly 180, with the understanding that the description thereof is germane to the first rear folding assembly 178.

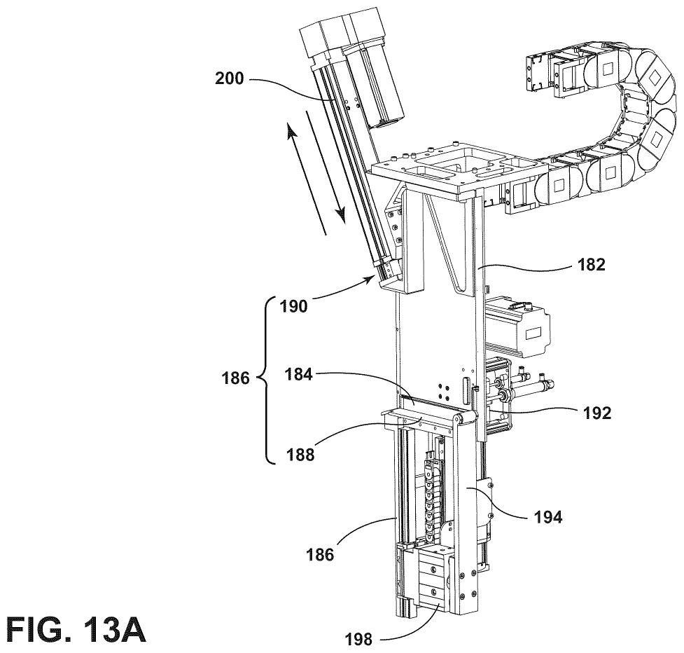

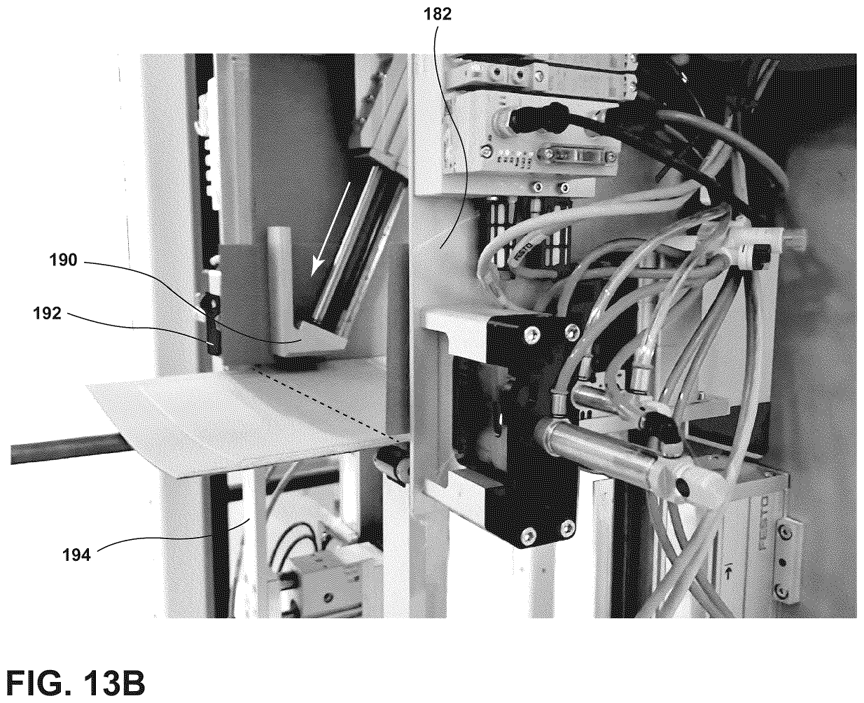

As can be seen in FIG. 13A, the second rear folding assembly 180 includes a frame 182 that is movably connected to the track 176. An advancement mechanism 184 is mounted on the frame 182 and is configured to engage and advance the partially and completely fold box through the rear folding unit 118. In the illustrated embodiment, the advancement mechanism 184 is a rotatable belt that is configured to engage the upwardly folded side panel of the partially and completely folded box. In other embodiments, the advancement mechanism 184 may be a rotatable belt that is configured to engage the bottom panel of the box.

The second rear folding assembly 180 also includes a clamp 186. The clamp 186 includes a support surface 188 and a presser foot 190. Further, the second rear folding assembly 180 includes a glue flap folder 192 and a rear end wall folder 194. The rear end wall folder 194 is movably connected to a track 196 and optionally an actuator 198 for additional movement.

Advancement of the partially folded box through the rear folding unit 118 can be paused when a crease between a rear wall panel and the bottom panel of the partially folded box is aligned with a proximal edge of a support surface 188 and/or when a crease between a sidewall and a rear glue flap is aligned with or just past the glue flap folder 192. Once the partially folded box is so positioned, the clamp 186 may be activated to hold the partially folded box in place. More specifically, the presser foot 190 may be moved into engagement with the bottom panel of the partially folded box so that the bottom panel is clamped between the presser foot 190 and the support surface 188.

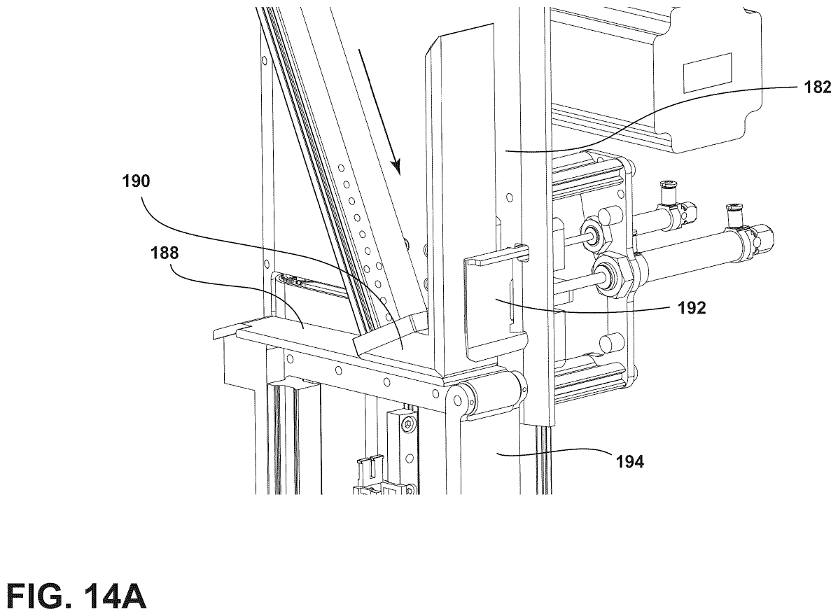

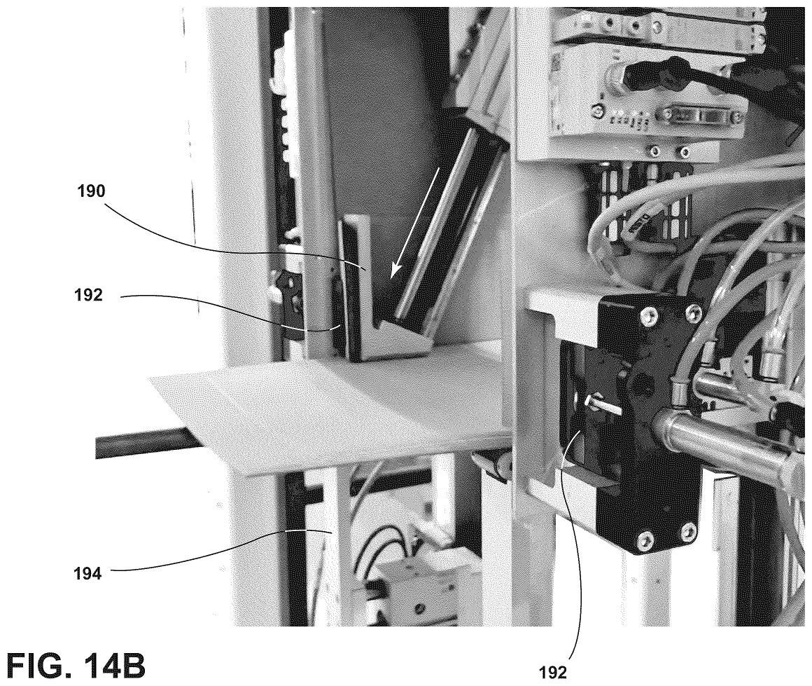

FIG. 13A illustrates the presser foot 190 is a raised position. When the presser foot 190 is in the raised position, the newly formed front end of the box (including the now vertical front wall panel) can pass underneath the presser foot 190. After the front end of the box has passed underneath the presser foot 190, the presser foot 190 can be moved to the lowered or clamped position, as shown in FIGS. 13B-14B. When the presser foot 190 is in the lowered or clamped position, a proximal edge thereof may be aligned with or just distal to a crease (shown in dashed lines in FIG. 14B) formed between the bottom panel and the rear wall panel of the partially folded box.

In the illustrated embodiment, the presser foot 190 moves in a diagonal direction between the raised/unclamped position and the lowered/clamped position. The diagonal movement of the presser foot 190 can increase the operational speed of the system by allowing the presser foot to being movement towards the clamped position as soon as the front end of the partially folded box has passed under the presser foot 190. In other embodiments, the presser foot 190 may move in a vertical direction, similar to the presser foot 164. In any case, the presser foot 190 can be moved via an actuator 200, such as a piston, motor, worm gear, or the like.

With the partially fold box template held in place by the clamp 186, additional portions of the box template can be folded. For instance, as shown in FIGS. 14A-14B, the glue flap folder 192 can be activated to fold a rear glue flap on the partially folded box. In the illustrated embodiment, the glue flap folder 192 moves linearly through a slot in the frame 182 to engage and fold the rear glue flap. An outer proximal edge of the presser foot 190 may support the box template and help ensure that the rear glue flap folder 192 folds the box template along a crease formed between the rear glue flap and the side panel of the box template.

While the glue flap folder 192 is shown and described as moving linearly to fold the rear glue flap, this is merely exemplary. In other embodiments, the glue flap folder 192 may pivot or make another non-linear movement to engage and fold the rear glue flap.

With the glue flap folded, the rear end wall panel of the box template can then be folded up to form a rear end of the box. As with the front wall panel folding process, folding the rear end wall panel can be accomplished in two stages. In the first stage, the rear end wall panel can be partially folded enough to be able to engage the folded glue flaps and limit or prevent them from unfolding. Once the rear end wall panel is partially folded, the glue flap folders (glue flap folder 192) can be withdrawn and the rear end wall panel can be fully folded into engagement with the rear glue flaps. The two stage folding process allows for the glue flap folders to be withdrawn and the rear end wall panel to be folded into engagement with the rear glue flaps without the glue flaps unfolding or undesirably transferring glue from the rear end wall panel to the glue flap folders.

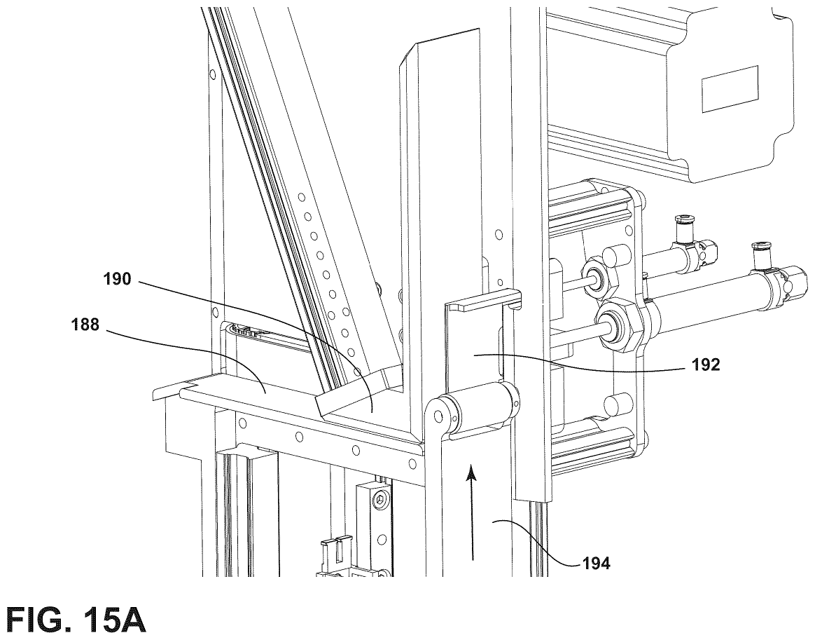

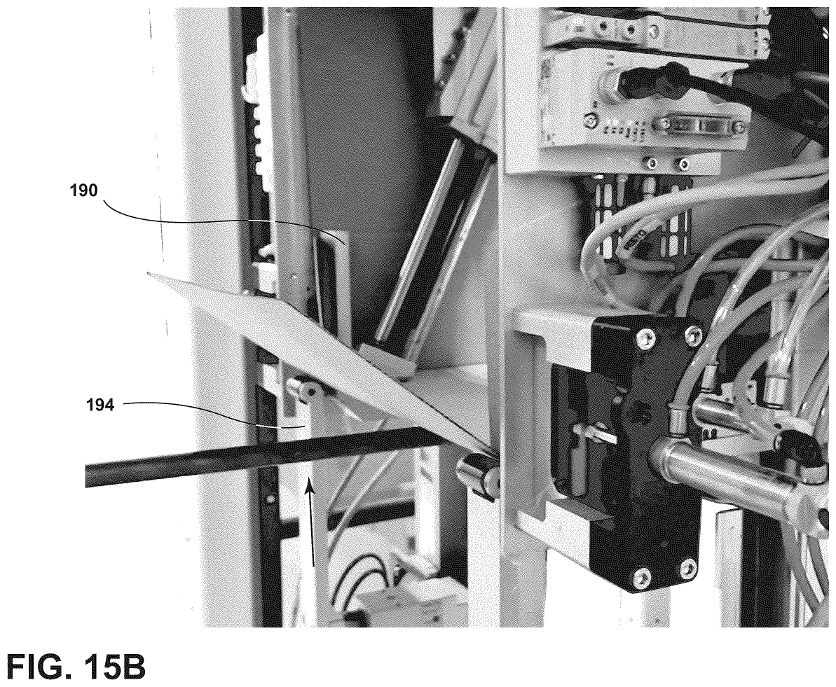

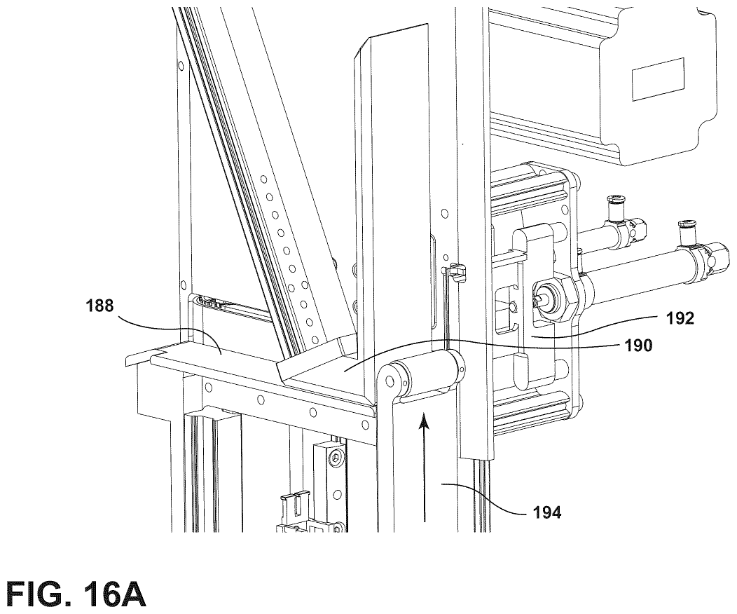

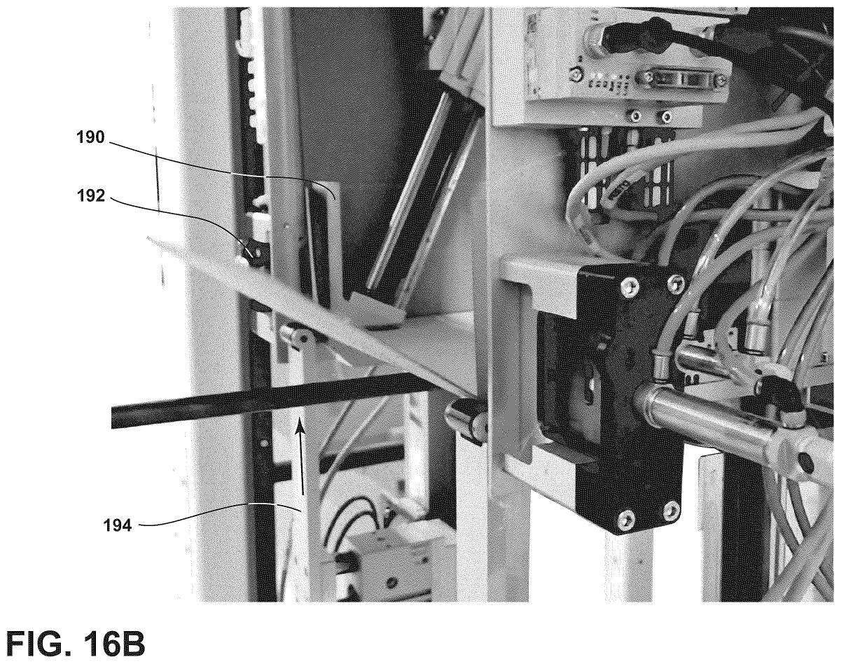

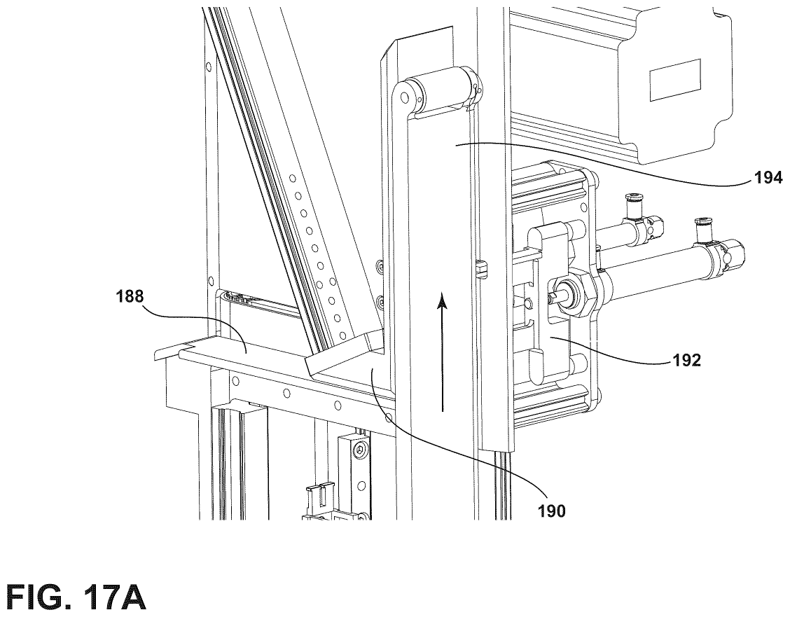

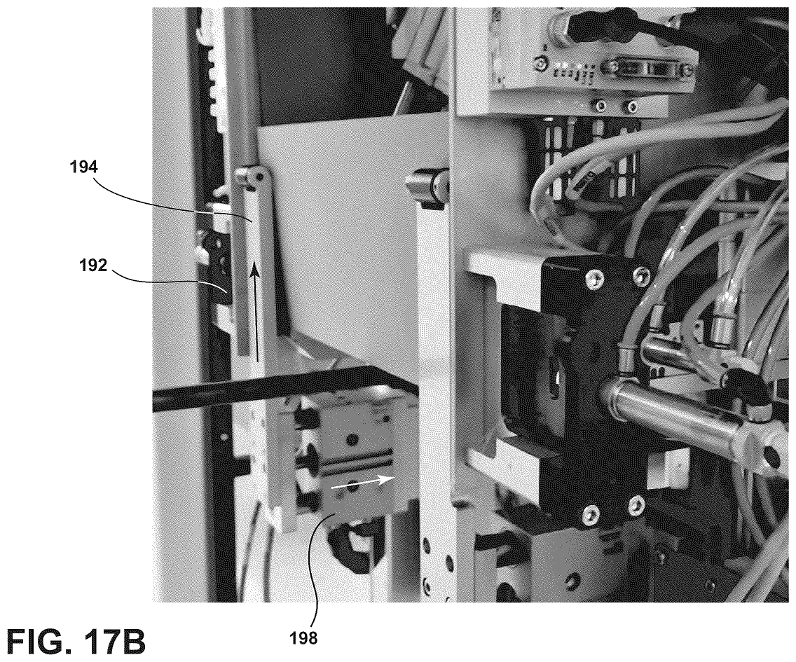

FIGS. 15A-16A illustrate the first stage of the rear end wall folding process and FIGS. 16B-17B illustrate the second stage. As can be seen in FIGS. 15A-15B, the first stage of the rear end wall panel folding process begins with the rear end wall folder 194 moving in the direction of the illustrated arrow to engage an outer surface of the rear end wall panel and partially folding the rear end wall panel towards the rear glue flaps. As noted, partially folding the rear end wall panel enables the rear end wall panel to engage the bottom edges of the rear glue flaps, which can limit or prevent the rear glue flaps from unfolding when the glue flap folders are withdrawn.

The degree to which the rear end wall panel is folded during the first stage can vary from one embodiment to another. For instance, the rear end wall panel can be folded to an angle anywhere between 5° and 80°. The rear end wall panel is folded far enough to engage the bottom edges of the rear glue flaps (to prevent them from unfolding) but not so far that the glue on the front end wall panel (seen in FIG. 14B) touches the glue flap folders.

With the rear end wall panel folded sufficiently to prevent the rear glue flaps from unfolding, the glue flaps folders can be withdrawn as shown in FIGS. 16A-16B. Withdrawing the glue flap folders exposes the outer surfaces of the rear glue flaps to which the rear end wall panel are to be secured. Thereafter, the rear end wall folder 194 can move further in the direction illustrated by the arrow, as shown in FIGS. 17B-17B, to further and completely fold the rear end wall panel. When the rear end wall panel is completely folded, the glue on the rear end wall panel can engage the rear glue flaps to secure the rear end wall panel and the rear glue flaps together, thereby forming a rear end of the box.

In some embodiments, the rear end wall folder 194 can also move in a direction (illustrated by the arrow in FIG. 17B) towards the rear glue flaps (via the actuator 198) to compress the rear end wall panel and the rear glue flaps together with the glue therebetween. An edge or side of the presser foot 190 may provide a support surface against which the rear end wall folder 194 can press the rear end wall panel and the rear glue flaps.

Once the rear end of the box is formed, the box is fully formed. Thereafter, the clamp 186 can be released and the box can be advanced out of the rear folding unit 118. More specifically, the presser foot 190 can be raised to unclamp the bottom panel of the box. The diagonal movement of the presser foot 190 causes the presser foot 190 to be raised and moved in the advancement direction of the box. As a result, the box can begin advancing further through the rear folding unit 118 even before the presser foot 190 is fully retracted out of the box. This can increase the operational speed of the system compared to a presser foot that only moves vertically and thereby has to be completely withdrawn from the box before the box can resume its advancement.

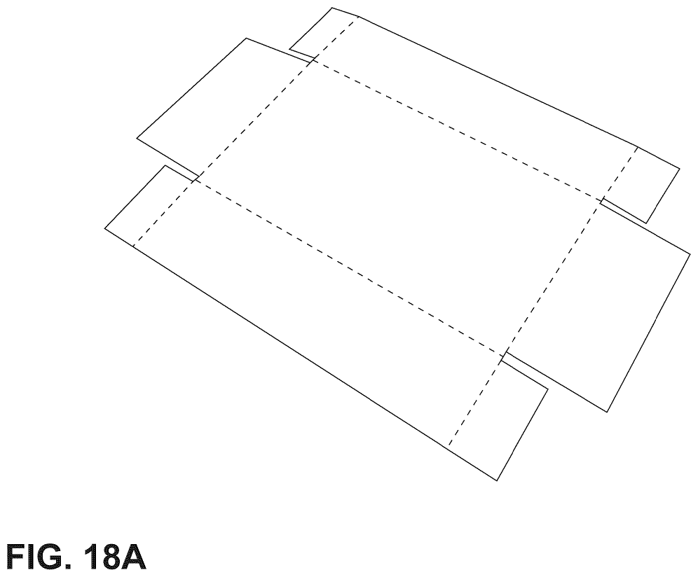

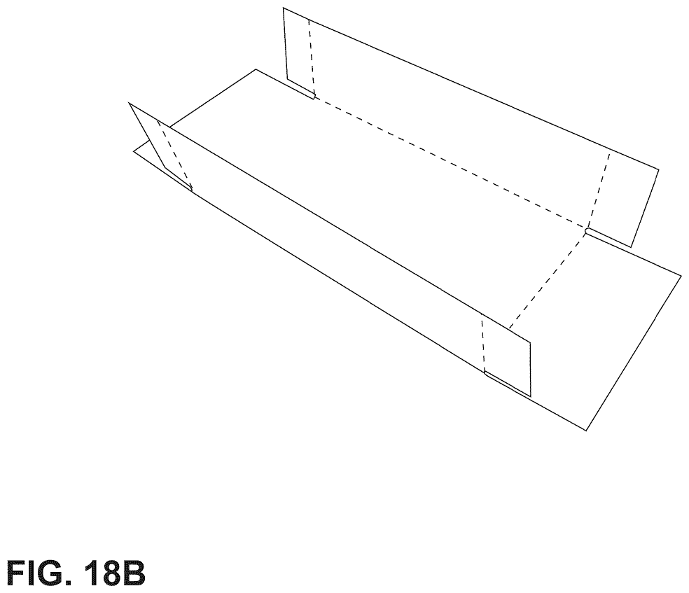

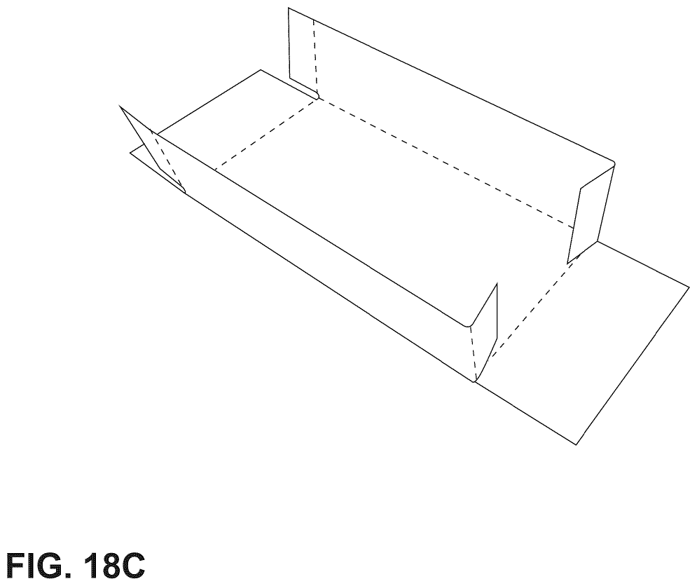

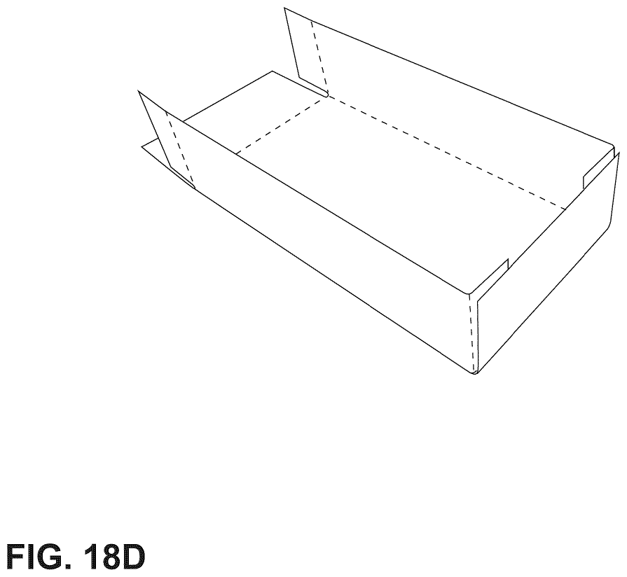

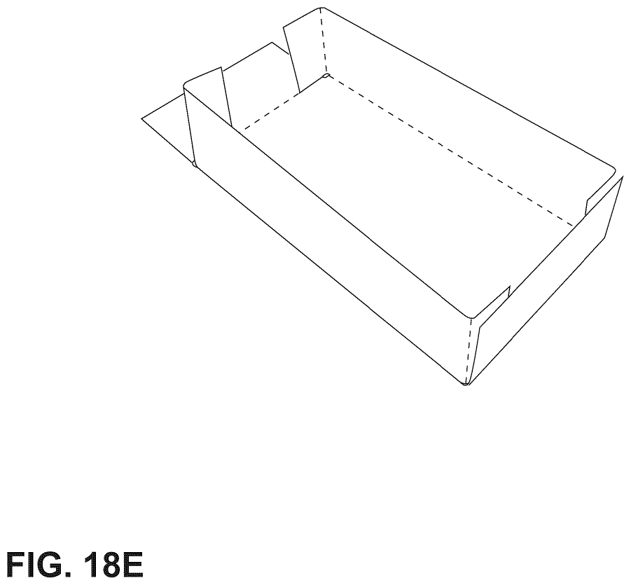

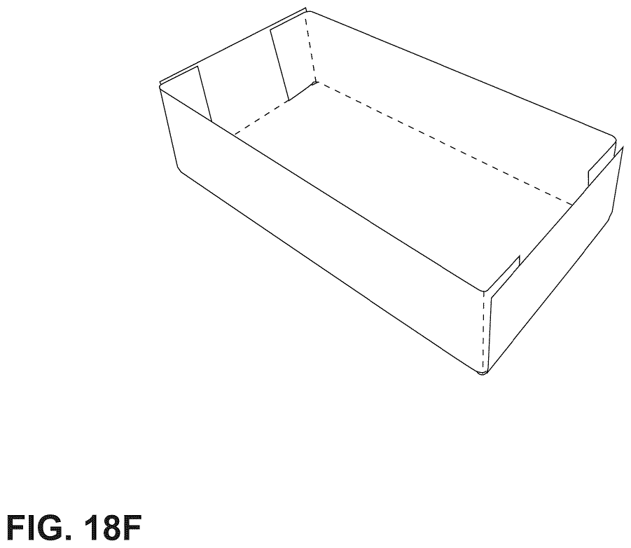

FIGS. 18A-18F illustrate an example folding process of a box template into a box as performed by the folding module 106. FIG. 18A illustrates an example box template with a bottom panel in the middle. Extending from the bottom panel are front and rear end wall panels and sidewall panels. Extending from each of the sidewall panels are front and rear glue flaps.

As shown in FIG. 18B, the initial folding step includes folding the sidewall panels relative to the bottom panel. This can be accomplished with the side folding unit 112. The next step includes folding the front glue flaps in towards the interior of the box, as shown in FIG. 18C. This can be done with the glue flap folders of the front folding unit 116. The front end wall is then folded up, as shown in FIG. 18D. Again, this is accomplished with the front folding unit 116. Furthermore, folding the front wall panel can be done in multiple stages as described herein. The rear glue flaps are then folded in, as shown in FIG. 18E. This can be done with the glue flap folders of the rear folding unit 118. The rear end wall is then folded up, as shown in FIG. 18F. This is also accomplished with the rear folding unit 118. Furthermore, folding the rear wall panel can be done in multiple stages as described herein.

In one embodiment, a system for forming boxes includes a folding and glue module. The folding and glue module includes a side folding unit configured to fold opposing sidewalls of a box template, a glue system configured to apply glue to selected portions of the box template as the box template advances through the side folding unit, a front folding unit configured to fold front glue flaps and a front wall panel of the box template, and a rear folding unit configured to fold rear glue flaps and a rear wall panel of the box template.

In some embodiments, the side folding unit comprises a first folding assembly and a second folding assembly, the first folding assembly being configured to fold a first sidewall of the box template and the second folding assembly being configured to fold a second sidewall of the box template.

In some embodiments, each of the first and second folding assemblies comprises a fold plate configured to fold the sidewall panels.

In some embodiments, the side folding unit further comprises a track, and the first and second folding assemblies being movable mounted on the track, the first and second folding assemblies being selectively movable closer together and further apart to accommodate box templates of different sizes.

In some embodiments, the first and second folding assemblies each comprise a fold plate that facilitates the folding of the sidewall panels.

In some embodiments, the glue system comprises a glue nozzle mounted on each of the fold plates of the first and second folding assemblies and configured to apply glue to desired portions of the box template.

In some embodiments, the front folding unit comprises a first track that extends at least partially between the side folding unit and the rear folding unit, and a second track movably mounted to the first track such that the second track can move at least partially between opposing ends of the first track.

In some embodiments, the first track and the second track are generally perpendicular to one another.

In some embodiments, the front folding unit further comprises a first front folding assembly and a second front folding assembly that are configured for folding front glue flaps and a front wall panel of the box template.

In some embodiments, the first front folding assembly and the second front folding assembly are movably mounted to the second frame, the first and second front folding assemblies being selectively movable closer together and further apart to accommodate box templates of different sizes.

In some embodiments, the first front folding assembly and the second front folding assembly each comprises a frame movably connected to the second track and a retention wall, the retention wall and the frame forming a gap through which an upwardly folded sidewall of the box template can pass through, such that the retention wall and the frame cooperate to hold the upwardly folded sidewall in the folded position.

In some embodiments, the first front folding assembly and the second front folding assembly each further comprises a clamp configured to selectively secure the box template in place during a folding process, the clamp comprising a support surface and a presser foot that is selectively movable to selectively clamp the box template in place.

In some embodiments, the first front folding assembly and the second front folding assembly each further comprises a glue flap folder this is configured to selectively fold a glue flap towards an interior of the box.

In some embodiments, the first front folding assembly and the second front folding assembly each further comprises a front end wall folder configured to fold a front end wall of the box template into engagement with the folded glue flaps.

In some embodiments, the front end wall folders of the first and second front folding assemblies are configured to fold the front end wall in a first stage and a second stage, in the first stage the front end wall folders fold the front end wall partially towards the glue flaps and while the glue flap folders are still holding the glue flaps in the folded configurations, and in the second stage the glue flap folders are withdrawn while the front end wall folders fold the front end wall into further engagement with the glue flaps.

In some embodiments, the front end wall folders are configured to move in a direction to compress the front end wall and the glue flaps together.

In some embodiments, the first front folding assembly and the second front folding assembly each further comprises an advancement mechanism configured to engage and selectively advance the box template through the front folding unit.

In some embodiments, the rear folding unit comprises a first rear folding assembly and a second rear folding assembly that are configured for folding rear glue flaps and a rear wall panel of the box template.

In some embodiments, the first rear folding assembly and the second rear folding assembly are movably mounted to a track, the first and second rear folding assemblies being selectively movable closer together and further apart to accommodate box templates of different sizes.

In some embodiments, the first rear folding assembly and the second rear folding assembly each further comprises an advancement mechanism configured to engage and selectively advance the box template through the rear folding unit.

In some embodiments, the first rear folding assembly and the second rear folding assembly each further comprises a clamp configured to selectively secure the box template in place during a folding process, the clamp comprising a support surface and a presser foot that is selectively movable to selectively clamp the box template in place.

In some embodiments, the presser foot is configured to move diagonally between a raised position and a clamped position.

In some embodiments, the first rear folding assembly and the second rear folding assembly each further comprises a glue flap folder this is configured to selectively fold a glue flap towards an interior of the box.

In some embodiments, the first front folding assembly and the second front folding assembly each further comprises a rear end wall folder configured to fold a rear end wall of the box template into engagement with the folded glue flaps.

In some embodiments, the rear end wall folders of the first and second rear folding assemblies are configured to fold the rear end wall in a first stage and a second stage, in the first stage the rear end wall folders fold the rear end wall partially towards the glue flaps and while the glue flap folders are still holding the glue flaps in the folded configurations, and in the second stage the glue flap folders are withdrawn while the rear end wall folders fold the rear end wall into further engagement with the glue flaps.

In some embodiments, the rear end wall folders are configured to move in a direction to compress the rear end wall and the glue flaps together.

In another embodiment, a system for forming boxes includes a folding module. The folding unit includes a side folding unit configured to fold opposing sidewalls of a box template, a front folding unit configured to fold front glue flaps and a front wall panel of the box template, and a rear folding unit configured to fold rear glue flaps and a rear wall panel of the box template. A portion of the front folding module is selectively movable between the side folding unit and the rear folding unit to transfer the box template therebetween.

In some embodiments, the front folding unit is configured to fold the front glue flaps and/or the front wall panel of the box template as the portion of the front folding unit moves between the side folding unit and the rear folding unit.

The present invention may be embodied in other specific forms without departing from its spirit or essential characteristics. The described embodiments are to be considered in all the tough to respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A system for forming boxes, the system comprising: a folding and glue module, comprising:
a side folding unit configured to fold opposing sidewalls of a box template;
a glue system configured to apply glue to selected portions of the box template as the box template advances through the side folding unit;
a front folding unit configured to fold front glue flaps and a front wall panel of the box template; and
a rear folding unit configured to fold rear glue flaps and a rear wall panel of the box template.

2. The system of claim 1, wherein the side folding unit comprises a first folding assembly and a second folding assembly, the first folding assembly being configured to fold a first sidewall of the box template and the second folding assembly being configured to fold a second sidewall of the box template.

3. The system of claim 2, wherein each of the first and second folding assemblies comprises a fold plate configured to fold the sidewall panels.

4. The system of claim 2, wherein the side folding unit further comprises a track, and the first and second folding assemblies being movable mounted on the track, the first and second folding assemblies being selectively movable closer together and further apart to accommodate box templates of different sizes.

5. The system of any of claim 2, wherein the first and second folding assemblies each comprise a fold plate that facilitates the folding of the sidewall panels.

6. The system of claim 5, wherein the glue system comprises a glue nozzle mounted on each of the fold plates of the first and second folding assemblies and configured to apply glue to desired portions of the box template.

7. The system of claim 1, wherein the front folding unit comprises:
a first track that extends at least partially between the side folding unit and the rear folding unit; and
a second track movably mounted to the first track such that the second track can move at least partially between opposing ends of the first track.

8. The system of claim 7, wherein the first track and the second track are generally perpendicular to one another.

9. The system of claim 7, wherein the front folding unit further comprises a first front folding assembly and a second front folding assembly that are configured for folding front glue flaps and a front wall panel of the box template.

10. The system of claim 9, wherein the first front folding assembly and the second front folding assembly each comprises:
a frame movably connected to the second track; and
a retention wall, the retention wall and the frame forming a gap through which an upwardly folded sidewall of the box template can pass through, such that the retention wall and the frame cooperate to hold the upwardly folded sidewall in the folded position.

11. The system of claim 9, wherein the first front folding assembly and the second front folding assembly are movably mounted to the second track, the first and second front folding assemblies being selectively movable closer together and further apart to accommodate box templates of different sizes.

12. The system of claim 11, wherein the first front folding assembly and the second front folding assembly each further comprises:
a clamp configured to selectively secure the box template in place during a folding process, the clamp comprising a support surface and a presser foot that is selectively movable to selectively clamp the box template in place.

13. The system of any of claim 11, wherein the first front folding assembly and the second front folding assembly each further comprises:
a glue flap folder this is configured to selectively fold a glue flap towards an interior of the box.

14. The system of claim 13, wherein the first front folding assembly and the second front folding assembly each further comprises:
a front end wall folder configured to fold a front end wall of the box template into engagement with the folded glue flaps.

15. The system of claim 14, wherein the front end wall folders of the first and second front folding assemblies are configured to fold the front end wall in a first stage and a second stage, in the first stage the front end wall folders fold the front end wall partially towards the glue flaps and while the glue flap folders are still holding the glue flaps in the folded configurations, and in the second stage the glue flap folders are withdrawn while the front end wall folders fold the front end wall into further engagement with the glue flaps.

16. The system of claim 14, wherein the front end wall folders are configured to move in a direction to compress the front end wall and the glue flaps together.

17. The system of claim 9, wherein the first front folding assembly and the second front folding assembly each further comprises an advancement mechanism configured to engage and selectively advance the box template through the front folding unit.

18. The system of claim 1, wherein the rear folding unit comprises a first rear folding assembly and a second rear folding assembly that are configured for folding rear glue flaps and a rear wall panel of the box template.

19. The system of claim 18, wherein the first rear folding assembly and the second rear folding assembly are movably mounted to a track, the first and second rear folding assemblies being selectively movable closer together and further apart to accommodate box templates of different sizes.

20. The system of claim 18, wherein the first rear folding assembly and the second rear folding assembly each further comprises an advancement mechanism configured to engage and selectively advance the box template through the rear folding unit.

21. The system of claim 18, wherein the first rear folding assembly and the second rear folding assembly each further comprises:
a clamp configured to selectively secure the box template in place during a folding process, the clamp comprising a support surface and a presser foot that is selectively movable to selectively clamp the box template in place.

22. The system of claim 21, wherein the presser foot is configured to move diagonally between a raised position and a clamped position.

23. The system of claim 18, wherein the first rear folding assembly and the second rear folding assembly each further comprises:
a glue flap folder this is configured to selectively fold a glue flap towards an interior of the box.

24. The system of claim 18, wherein the first rear folding assembly and the second rear folding assembly each further comprises:
a rear end wall folder configured to fold a rear end wall of the box template into engagement with the folded glue flaps.

25. The system of claim 24, wherein the rear end wall folders of the first and second rear folding assemblies are configured to fold the rear end wall in a first stage and a second stage, in the first stage the rear end wall folders fold the rear end wall partially towards the glue flaps and while the glue flap folders are still holding the glue flaps in the folded configurations, and in the second stage the glue flap folders are withdrawn while the rear end wall folders fold the rear end wall into further engagement with the glue flaps.

26. The system of claim 24, wherein the rear end wall folders are configured to move in a direction to compress the rear end wall and the glue flaps together.

27. A system for forming boxes, the system comprising: a folding module, comprising:
a side folding unit configured to fold opposing sidewalls of a box template;
a front folding unit configured to fold front glue flaps and a front wall panel of the box template; and
a rear folding unit configured to fold rear glue flaps and a rear wall panel of the box template,
wherein a portion of the front folding module is selectively movable between the side folding unit and the rear folding unit to transfer the box template therebetween.

28. The system of claim 27, wherein the front folding unit is configured to fold the front glue flaps and/or the front wall panel of the box template as the portion of the front folding unit moves between the side folding unit and the rear folding unit.
